(19) United States
(12) Patent Application Publication
(10) Pub. No.: US 2014/0201013 A1
(43) Pub. Date: Jul. 17, 2014

(54) COMPACT PORTABLE POINT-OF-SALE COUNTER

(71) Applicant: Russel Don DSOUZA, Dubai (AE)

(72) Inventor: Russel Don DSOUZA, Dubai (AE)

(21) Appl. No.: 14/154,626

(22) Filed: Jan. 14, 2014

Related U.S. Application Data
(60) Provisional application No. 61/752,471, filed on Jan. 15, 2013.

(51) Int. Cl. G06Q 20/20

(52) U.S. Cl. CPC G06Q 20/20; G06Q 20/204; G06Q 20/206
USPC 705/17; 705/16; 705/18

(57) ABSTRACT

The present disclosure provides a compact portable point of sale (POS) device. The POS device is capable of being folded for easy transportation of the POS device by a user. The POS device includes a box unit having a cash register with a plurality of compartments, some of which are adapted to store currency notes and coins. Further, the POS device includes a pivotable tray hinged to the box unit for covering the cash register. The tray is adapted to receive a keyboard thereon. Furthermore, the POS device includes a tablet type computing device capable of being detachably attached to the box unit. The tablet has a display screen and is connected to the keyboard. After use of the POS device, the user is capable of folding the pivotable tray and the tablet for making the POS device portable in nature.

### CROSS REFERENCE TO RELATED APPLICATIONS

This application claims the priority and benefits from U.S. application No. 61/752,471 filed at USPTO on 15 Jan. 2013.

### FIELD OF THE DISCLOSURE

The present disclosure generally relates to a compact and portable Point of Sale (POS) counter or device, and more particularly, relates to a POS device capable of being easily folded and easily transported by a user.

### BACKGROUND OF THE DISCLOSURE

Conventional POS devices include several hardware components, such as screens, monitors (with or without touch feature), customer displays, magnetic stripe readers (MSR), central processing units (CPU), keyboards, mouse, cash registers, barcode scanners and receipt printers. Due their tremendous utility and ease of operation, these devices are becoming omnipresent in shopping malls, kiosks, retail stores, departmental stores and the like.

However, conventional POS devices are bulky and non-portable. Most of these devices have high power consumption and require extensive cabling to power various sub components of such conventional POS devices. Further, for operating these POS devices technically trained staff is required, especially to configure and manage the complex hardware involved. The cabling involved in such POS devices are intricate and messy, leading to grave inconvenience to the users.

More importantly, these conventional POS devices require large volume of space for storing and stacking. This is very burdensome for large retailers, departmental stores and mall owners, as they usually face severe space crunch in their facilities. Such retail stores have limited space and budget, and need POS devices that are lightweight, handy, portable and compact. Moreover, with the increasing fascination of device owners, many device owners these days want devices that are good looking, and aesthetically appealing.

Therefore, there is a need of developing POS devices which are trendy, good looking and aesthetically appealing. Further, there is a need to develop POS devices which are compact in size, and are highly portable. Furthermore, there is a need to develop POS devices which include multiple sub devices, such as printer and card readers in one single device. Moreover, there is a need to develop POS devices which are easy to operate.

### SUMMARY OF THE DISCLOSURE

In view of the foregoing disadvantages inherent in the prior-art, the general purpose of the present disclosure is to provide a compact portable point of sale (POS) device that is configured to include all advantages of the prior art and to overcome the drawbacks inherent in the prior art offering some added advantages.

To achieve the above objectives and to fulfill the identified needs, in one aspect, the present disclosure provides a compact portable point of sale (POS) device. The POS device is capable of being folded for easy transportation of the POS device by a user. This provides handiness and portability to the device. The POS device includes a box unit. The box unit has a cash register. The cash register includes a plurality of compartments, some of which are capable of storing currency notes and coins.

The POS device further includes at least one pivotable tray hinged to the box unit. The pivotable tray is adapted to cover the cash register. The tray is further adapted to receive a keyboard thereon. The POS device further includes at least one tablet type computing device capable of being detachably attached to the box unit. The computing device has a display screen and is capable of being connected to the keyboard for allowing operation of the computing device by the user.

In one embodiment, the computing device further includes at least one 1D/2D/3D bar code reader for reading bar codes, a magnetic stripe reading interface for reading credit cards and other data storing cards, one or more USB ports, a SD card reading port and one or more communication ports, all configured at an outer periphery of the computing device.

The user is able to use the POS device for various transactions, and after use of the POS device, the user is capable of folding the pivotable tray and is capable of folding the detachable tablet type computing device for providing foldability and portability to the POS device.

This together with the other aspects of the present invention along with the various features of novelty that characterized the present disclosure is pointed out with particularity in claims annexed hereto and forms a part of the present invention. For better understanding of the present disclosure, its operating advantages, and the specified objective attained by its uses, reference should be made to the accompanying descriptive matter in which there are illustrated exemplary embodiments of the present invention.

### BRIEF DESCRIPTION OF THE DRAWINGS

The advantages and features of the present disclosure will become better understood with reference to the following detailed description and claims taken in conjunction with the accompanying drawing, in which:

FIGS. 1, 7 are perspective views of a compact portable point of sale (POS) device in a folded position, according to an embodiment of the present disclosure;

FIG. 2 is a perspective view of the POS device of FIG. 1, in an open position, according to an embodiment of the present disclosure;

FIG. 3 is a flow diagram of a perspective view of the POS device of FIG. 1 with a pivotable tray in an operative position, according to an embodiment of the present disclosure;

FIG. 4 is a perspective view of a tablet type computing device, which is part of the POS device, according to an embodiment of the present disclosure;

FIG. 5 is a perspective view of the POS device of FIG. 1, with the tablet type computing device as shown in FIG. 4, being detached from the POS device, according to an embodiment of the present disclosure; and

FIG. 6 is a back view of the POS device of FIG. 1, with a touch enabled customer display screen being shown, according to an embodiment of the present disclosure;

Like numerals refer to like elements throughout the present disclosure.

### DETAILED DESCRIPTION OF THE DISCLOSURE

The exemplary embodiments described herein detail for illustrative purposes are subject to many variations in structure and design. It should be emphasized, however, that the present disclosure is not limited to particular POS device as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The use of terms “including,” “comprising,” or “having” and variations thereof herein is meant to encompass the items listed thereafter and equivalents thereof as well as additional items.

Further, the terms, “a” and “an” herein do not denote a limitation of quantity, but rather denote the presence of at least one of the referenced item.

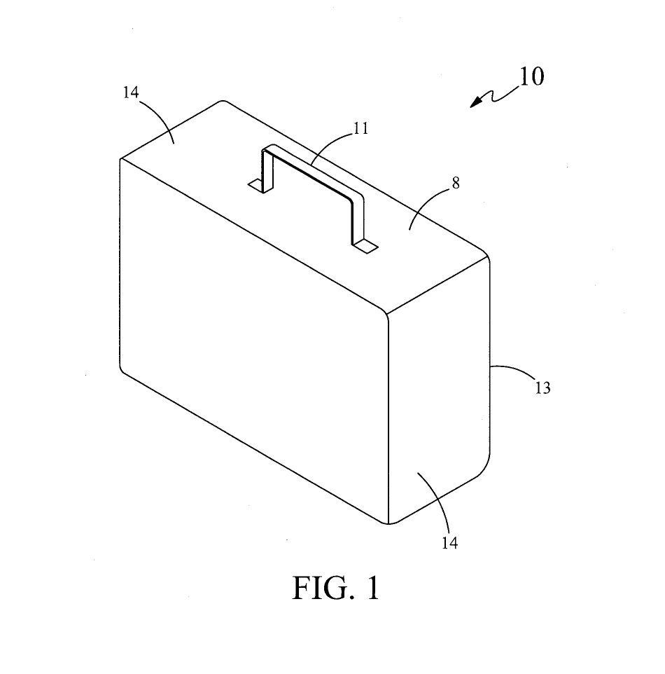

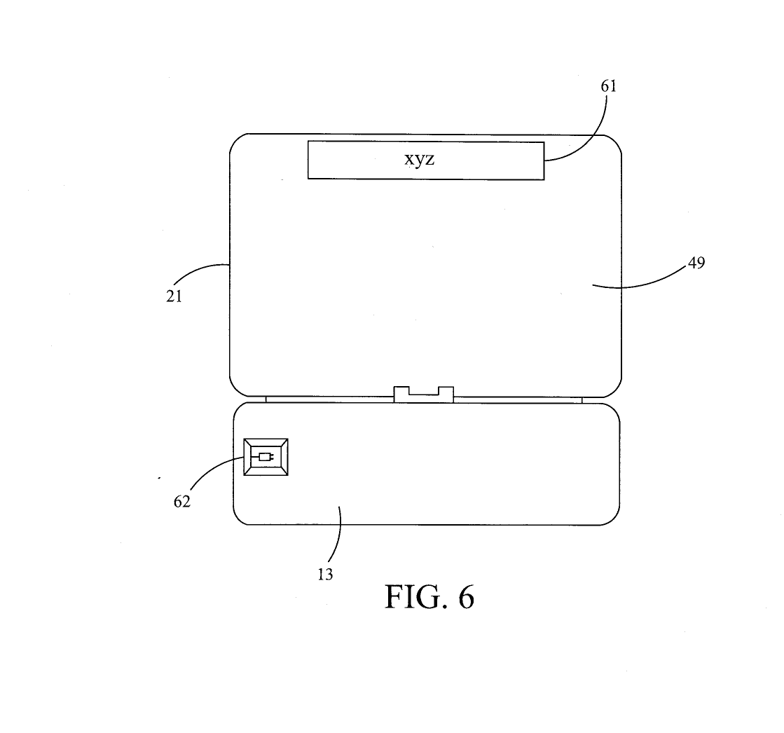

The present disclosure provides a compact portable point of sale (POS) device. The POS device is capable of being folded for easy transportation of the POS device by a user. The POS device is as shown in FIGS. 1-7, and will now be explained.

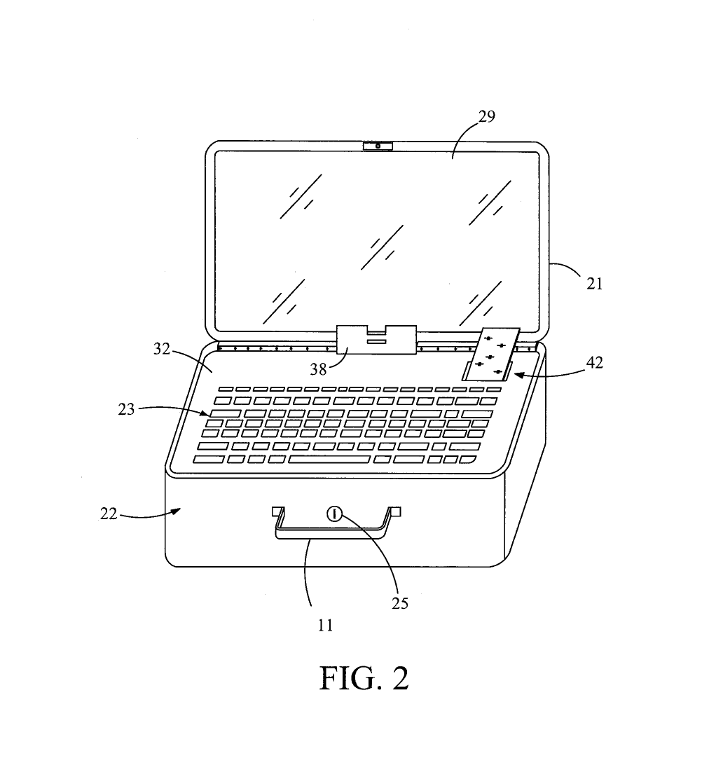

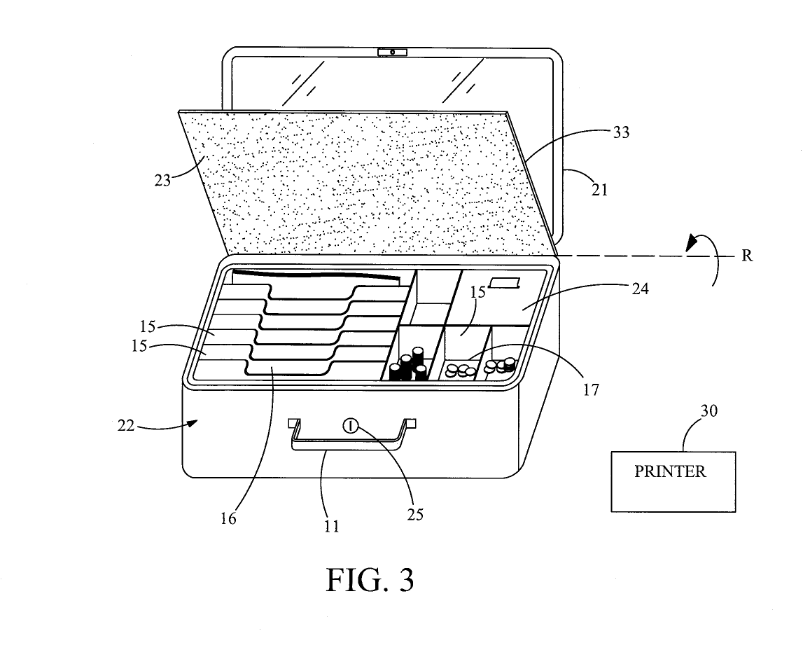

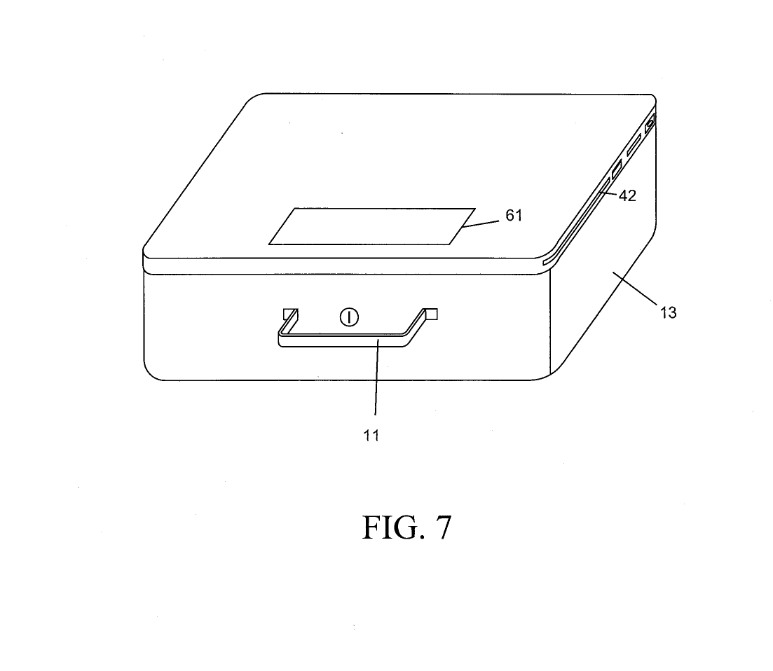

Referring to FIGS. 1, 7, there are shown a POS device 10 in a folded position. FIG. 2 on the other hand shows the POS device 10 in an open position. FIG. 3 shows the POS device 10 in an operational state. As shown in these FIGS. 1-3, the POS device 10 includes a box unit 13. The box unit 13 is composed of highly rigid materials. In one embodiment, the box unit 13 is composed of plastic materials. In another embodiment, the box unit 13 is composed of metallic materials. In yet another embodiment, the box unit 13 is composed of composite materials.

Further, the box unit 13 includes a cash register 22 having a plurality of compartments 15. As shown, few of the plurality of compartments 15 are adapted to store currency notes and coins. For example, as shown in FIG. 3, the compartment 16 is used for storing notes, whereas the compartment 17 is used for storing coins. More specifically, the note storing compartment 16 is shaped like an extended horizontal cavity to allow various sized notes to be received therein. On the other hand, the coin storing compartment 17 is box shaped cavities to receive various size shaped coins to be stored therein. This allows the user to store various notes and coins in the cash register 22 of the POS device 10 during operation thereof. It should be clearly understood that the number of compartments 15 as shown in the FIG. 3 are only exemplary in nature, and the cash register 22 may be designed to include as many compartments 15 as required by the user.

In one embodiment of the present invention, one of the compartments 24 is capable of receiving a printer 30 therein. This allows the POS device 10 to encompass the printer 30 therein, thereby adding to the compactness of the POS device 10, and further allows the user to generate various receipts, or perform other printing purposes required for the POS device 10, such as printing labels and the like. In addition, the cash register 22 may include various other compartments, such as compartments for storing paper rolls that may be required to print various receipts using the printer 30, and other utility compartments. The compartments 15 may be made of customized sizes and are composed of same materials as for the box unit 13.

In one embodiment of the present disclosure, the box unit 13 further includes a handle 11. This handle 11 is configured on outer periphery 14 of the box unit 13, and allows the POS device 10 to be held by the user. In one embodiment, the handle 11 is attached on an edge 8 of the box unit 13. However, such configuration of the handle 11 should not be construed as a limitation to the present disclosure. Accordingly, in one embodiment, the handle 11 may be attached at one of the other edges of the box unit 13. Further, the handle 11 is composed of metallic materials, or other polymeric materials, however, such composition should not be construed as a limitation to the present disclosure.

The POS device 10 further includes at least one pivotable tray 23 hinged to the box unit 13. The pivotable tray 23 is rotatable about an axis “R”, and allows for covering the cash register 22 for concealing the contents of the cash register 22, and further allows for uncovering the cash register 22 for revealing the contents of the cash register 22 and accessing the contents thereof. The pivotable tray 23 may be adapted to snuggly fit into the edges of the box unit 13. The pivotable tray 23 includes a slot 42 therein, congruently configured over the compartment 24, such that, the paper from the printer 30 can be exited from the cash register 22 during operation of the POS device 10.

Further, the pivotable tray 23 is capable of receiving a key board 32 therein. More specifically, the pivotable tray 23 is capable of receiving the key board 32 on it's outer surface 33. This allows the user to place and lock using locking means the key board 32 on the pivotable tray 23 while operating the key board 32 for data inputs into the POS device 10, thereby adding further compactness to the POS device 10. The key board 32 further includes a track pad (not shown) which is capable of receiving directional inputs from the user, and especially touch based inputs from the user.

The key board 32 is designed to be rugged, compact and long lasting with strong keys. The key board 32 is waterproof and spill resistant. The key board 32 may include a replaceable protective film, for protecting the key board 32 from external harsh environment conditions. In one embodiment, the key board 32 is composed of highly rigid materials. In another embodiment, the key board 32 is composed of plastic materials. In yet another embodiment, the key board 32 is composed of metallic materials. In yet another embodiment, the key board 32 is composed of composite materials.

In one embodiment, the key board 32 is a dynamic key board with keys that can be changed for different languages. The functionalities of the key board 32 includes shortcut programming, and capability of being coupled with computing devices via USB cable or wirelessly using wireless communication protocols, such as Bluetooth®. The key board 32 may be battery operated or may be operable by driving power from USB ports of computing devices connected thereto.

The POS device 10 further includes at least one tablet type computing device 21. The tablet type computing device 21 is capable of being detachably attached to the box unit 13. The detachable attachment of the computing device 21 allows the user to release the computing device 21 from the POS device 10. This makes the computing device 21 removable, thereby adding to compactness, foldability and portability of the POS device 10. The computing device 21 can have variable size, but, is ideally of a size of 10.1 inches. However, such size ranges should not be construed as a limitation to the present disclosure.

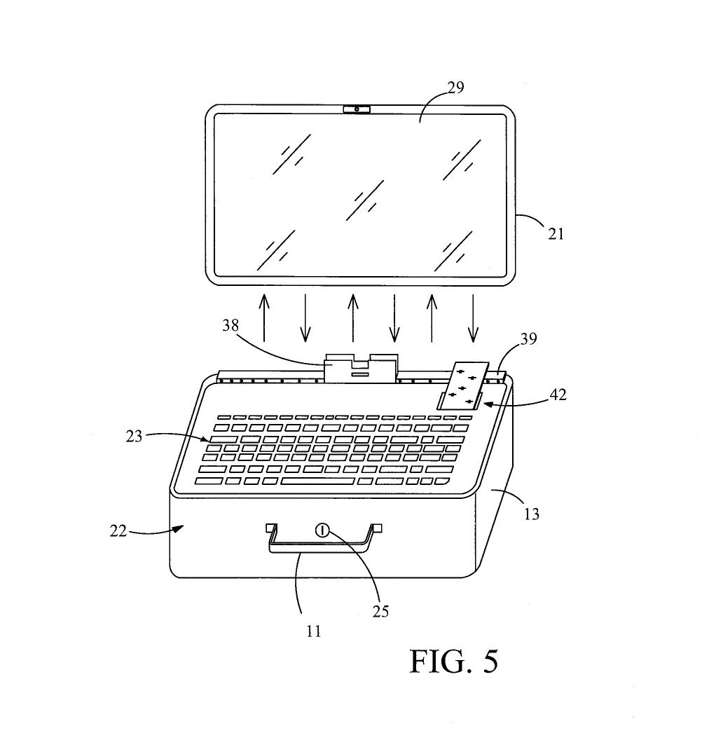

In one embodiment, the computing device 21 is detachably attached to the box unit 13 using a latching mechanism, such as a clip latch 38, as shown in FIGS. 2 and 5. More specifically, the clip latch 38 is configured on the box unit 13, and specifically proximal to an elongated edge portion 39 of the box unit 13, such that, the computing device 21 can be received inside the latch 38 and locked, thereby retaining the computing device 21 in an upright position. Further, the clip latch 38 allows the computing device 21 to swivel or rotate, giving adjustability to the computing device 21. The detachability mechanism is as shown in FIG. 5, wherein the clip latch 38 can be unlocked by swiping an internal lock, and the clip latch 38 can be released to remove the computing device 21 from the base unit 13.

The computing device 21 is operationally coupled or paired to the key board 32 using a USB interface or wirelessly through Bluetooth® connectivity. This enables the user to input directions in the computing device 21. The outer body of the computing device 21 may be composed of materials similar to the box unit 13.

Further, the computing device 21 may include processors having processing capability of 1 Ghz or higher, storage memory of 16 GB or more either FLASH or SSD type. Moreover, the computing device 21 may include an internal RAM of 1 GB or higher, and may be operable on known in the art operating systems, such as Android 4.2 or higher, adapted to run the POS device 10. The computing device 21 may be further powered by Li-ion batteries, adapted to provide sufficient power back up to the computing device 21.

The computing device 21 further has a display screen 29 capable of displaying the contents of the computing device 21. In one embodiment, the display screen 29 is a touch enabled screen. In another embodiment, the display screen 29 is a stylus enabled screen. However, it should be understood that such examples of input should not be construed as a limitation to the present disclosure, and the display screen 29 may be adapted to receive other type of inputs, such as gesture input, and the like. The above feature of the display screen 29 allows the user to input data in the computing device 21 using either the stylus or touch inputs. Further, the display screen 29 is composed of resilient unbreakable glass, which is scratch free, such as Corning Gorilla glass. In one embodiment, the display screen 29 may be 10.1 inches or higher in diameter, with an IP 55 or IP 65 rating. The display screen 29 has a minimum screen resolution of 1024 by 768, IPS LCD day light usable display.

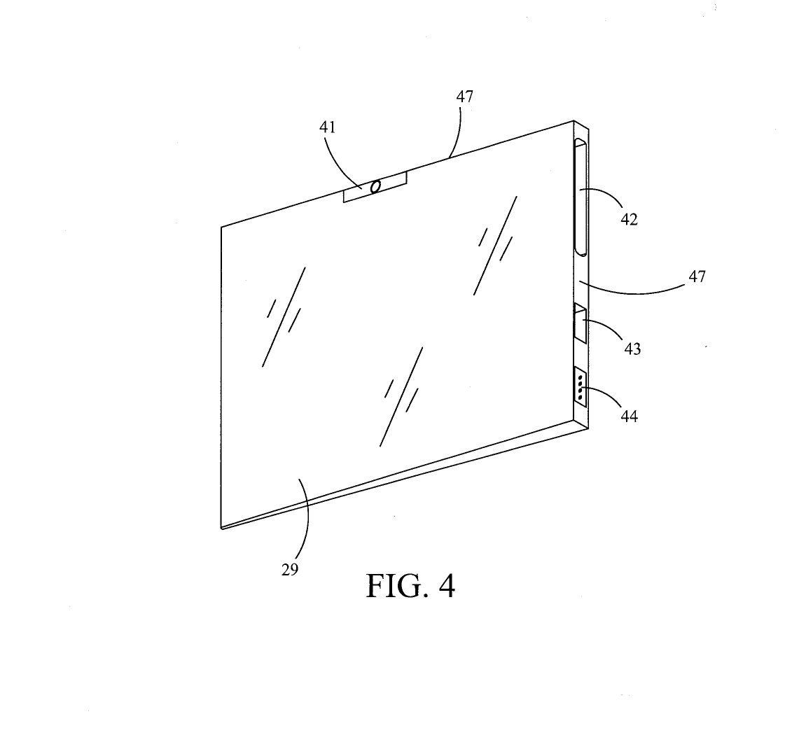

With specific reference to FIG. 4, the computing device 21 further includes various additional functionalities. The computing device 21 includes at least one detachably attached 1D/2D/3D barcode scanning module (not shown) having a reader 41 capable of reading barcodes. This allows for scanning of various bar codes and inputting of data in the computing device 21. The reader 41 is configured at an outer periphery 47 of the computing device 21, as shown in FIG. 4. However, such configuration of the reader 41 should not be construed as a limitation to the present disclosure.

Further, the computing device 21 includes one or more magnetic stripe reading modules (not shown) having a card reading interface 42 capable of reading card information. The card reading module may be coupled with Pinpads to allow user input of credit card verification PIN. This allows the user to swipe and read credit card information of customers. As shown in FIG. 4, the card reading interface 42 is configured at the outer periphery 47 of the detachable computing device 21.

In addition, the computing device 21 includes a USB module (not shown) having one or more USB ports 44, wherein the USB ports 44 are configured at the outer periphery 47 of the detachable computing device 21. In one embodiment, the USB ports 44 are micro USB type ports. The USB ports 44 allow plugging in of the USB devices into the computing device 21. Moreover, the computing device 21 also includes a SD card reading module (not shown) having one or more SD card reading ports 43, wherein the SD card reading ports 43 are configured at the outer periphery 47 of the detachable computing device 21.

Additionally, the computing device 21 includes a communication module (not shown) having one or more communication ports. These communication ports are configured at the outer periphery 47 of the computing device 21, and allow the computing device 21 to be connected to external networks, such as WANs, LANs, the internet and the like. Further, the communication module may further include 3G/GSM connectivity module for providing wireless 3G/GSM connectivity to the computing device 21.

In addition, the computing device 21 further includes an integrated microphone and speaker (not shown) with mini jack stereo, and a docking connector (not shown). The computing device 21 also includes one or more readers selected from the group consisting of a biometric reader, such as a Fingerprint ID reader for finger print recognition, and a RFID reader for reading RFID tags, for other compatible reading purposes. The computing device 21 may further include one or more cameras, HDMI cards, and other such conventional optional cards, such as NIC cards, like wireless WiFi cards, Bluetooth® cards, for providing additional functionalities to the computing device 21.

The POS device 10 further includes a locking mechanism for locking the POS device 10 to prevent unauthorized access of the POS device 10. More specifically, the POS device 10 includes a lock configured in the box unit 13. The lock couples the box unit 13 with the other parts of the POS device 10 for enabling them to be locked together. The POS device 10 includes a key hole 25 configured at the outer periphery 14 of the box unit 13. The key hole 25 is adapted to receive a key for unlocking the locking mechanism, thereby unlocking the box unit 13 and the other components of the POS device 10. The locking mechanism may include one or more levers, for providing the locking and unlocking means.

In one embodiment of the present invention, the POS device 10 further includes a detachably attached touch enabled customer display screen 61. The customer display screen 61 is configured at a back portion 49 of the computing device 21. The primary function of the customer display screen 61 is to receive inputs from the customer and displaying transaction information to a customer. The customer display screen 61 is LCD or LED based, and is coupled to the computing device 21 using wired or wireless means. In one embodiment, the customer display screen 61 is coupled to the computing device 21 using wireless means, such as Bluetooth® means.

Further, to meet the power needs of the POS device 10, the POS device 10 may include a power supply (not shown) which may be powered by external power source. The power supply may include a power socket 62 configured in the base unit 13. The power socket 62 may be adapted to receive power from the external power supply and distribute the power to the sub devices, such as the computing device 21, key board 32, and other power consuming devices of the POS device 10.

Further, it will be apparent to the person skilled in the art that the various components of the POS device 10 can be customized to be of various shapes, sizes and colours, according to the requirement of the user. Any such variations in these shapes, sizes and colours, should be construed as under the scope of the present disclosure. The overall size of the POS device 10 is as follows: H—120 mm, W—340 mm, D—244 mm.

The use of the POS device 10 will now be described with collective reference to FIGS. 1-5. The POS device 10 is initially in its closed position with the box unit 13 locked, as in FIG. 1. The user may carry around the POS device 10 using the handle 11 to a desired place where the POS device 10 is required to be operated. When the user has to use the POS device 10 device, the user may insert the key in the key hole 25, and unlock the POS device 10. Thereafter, the user may then flip open the computing device 21, to bring the computing device 21 in an upright position. The user can also swivel the computing device 21 to a position which is convenient to him.

Thereafter, the POS device 10 may power on the computing device 21. For this, the user may push the power button on a panel of the computing device 21 which runs the operating system of the computing device 21. The user may then insert data inputs on the key board 32, or provide touch based inputs on the display screen 29. The user may also use the track pad on the key board 32 to enter the information into the computing device 21. The user may also power off or lock the computing device 21 during the operation or put it in standby mode, if he so desires.

For various sale related activities, the user may use various sub devices in the POS device 10. For scanning information about items to be sold, the user may use the bar code scanner 41 to scan bar codes of various items for directly inputting the data corresponding to items in the POS device 10. The user may use the credit card interface 42 for swiping credit cards of the customers, the printer 29 for printing receipts, labels etc., and can perform many other functions. The user can also display the billing amount and other transaction details to the customer on the customer display screen 61.

Once the sale is complete, the user can receive cash from the customer for the items sold, and can open the cash register 22, by sliding the pivotable tray 23 in an upward direction. Thereafter, the user can safely stack the coins, notes, cheques and other valuables inside the cash register 22. After stacking, the user can close the cash register 22 and can temporarily lock the pivotable tray 23 into position.

In this manner, the user is able to operate the POS device 10 for performing various sale related activities. Once the sale is done, the user can fold the computing device 21 and can place it on the key board 32 being in its resting position. The user also has an option of detaching the computing device 21 from the box unit 13, if required. Thereafter, the user can lock the POS device 10 to restrict it's access. The user in this manner folds the POS device 10 into a compact, portable unit, and can easily transport the POS device 10 to any other location using the handle 11.

The advantages of the POS device 10 of the present invention are many fold. Firstly, the POS device 10 is highly compact and portable as compared to other POS devices. Further, the POS device 10 can do multiple functions at a time which are essential for performing sale related operations. Furthermore, the POS device 10 is trendy, good looking and aesthetically appealing. Moreover, the POS device 10 is very easy to operate, secure and highly safe.

The foregoing descriptions of specific embodiments of the present disclosure have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A compact portable point of sale (POS) device, the POS device capable of being folded for easy transportation of the POS device by a user, the POS device comprising:
a box unit having a cash register with a plurality of compartments, one or more of the plurality of compartments capable of storing currency notes and coins;
at least one pivotable tray hinged to the box unit for covering the cash register, the tray adapted to receive a keyboard thereon; and
at least one tablet type computing device capable of being detachably attached to the box unit, wherein the at least one computing device has a display screen and is capable of being connected to the keyboard for allowing operation of the computing device by the user,
wherein after use of the POS device, the user is capable of folding the pivotable tray and is capable of folding the detachable tablet type computing device for providing foldability and portability to the POS device.

2. The POS device of claim 1 further comprising a printer removably received in one of the plurality of compartments.

3. The POS device of claim 1, wherein the box unit comprises a handle for allowing the POS device to be held by the user.

4. The POS device of claim 1, wherein the computing device further comprises a detachably attached touch enabled customer display screen for receiving inputs from the customer and displaying transaction information to a customer.

5. The POS device of claim 1, wherein the computing device further comprises,
at least one detachably attached 1D/2D/3D barcode scanning module having a reader capable of reading barcodes, wherein the reader is configured at an outer periphery of the computing device,
one or more magnetic stripe reading modules having a card reading interface capable of reading card information, wherein the card reading interface is configured at the outer periphery of the detachable computing device,
a USB module having one or more USB ports, wherein the USB ports are configured at the outer periphery of the detachable computing device,
a SD card reading module having one or more SD card reading ports, wherein the SD card reading ports are configured at the outer periphery of the detachable computing device, and
a communication module having one or more communication ports, wherein the one or more communication ports are configured at the outer periphery of the computing device.

6. The POS device of claim 1, wherein the box unit, the computing device and the pivotable tray are composed of highly rigid materials.

7. The POS device of claim 6, wherein the materials are at least one of plastic materials, metallic materials, and composite materials.

8. The POS device of claim 1 further comprising a locking mechanism for locking the POS device to prevent unauthorized access of the POS device.

9. The POS device of claim 8, wherein the locking mechanism includes a key hole configured at an outer periphery of the box unit, wherein the key hole is adapted to receive a key for unlocking the locking mechanism.

10. The POS device of claim 1, wherein the display screen is at least one of a touch enabled screen, and a stylus enabled screen.

11. The POS device of claim 1, wherein the display screen is composed of resilient glass.

12. The POS device of claim 1, wherein the computing device is adapted to receive inputs from the user via the keyboard connected to the computing device.

13. The POS device of claim 1, wherein the keyboard comprises a track pad capable of being operated by the user for providing inputs to the computing device.

14. The POS device of claim 1 further comprising a latching mechanism configured on the box unit, the latching mechanism adapted to detachably attach and swivel 360 degrees the computing device with the box unit.

15. The POS device of claim 1, wherein the computing device further comprises,
an integrated microphone and speaker with input and output ports, and
a docking connector at the outer periphery of the computing device.

16. The POS device of claim 1 further comprising one or more readers selected from the group consisting of a biometric reader, and a RFID reader.

17. The POS device of claim 1 further comprising one or more cameras.

18. The POS device of claim 1, wherein the computing device is detachably attached to an elongated edge portion of the box unit.

19. The POS device of claim 1, wherein the pivotable tray is hinged to an elongated edge portion of the box unit.
